(19) United States
(12) Patent Application Publication
(10) Pub. No.: US 2024/0358577 A1
(43) Pub. Date: Oct. 31, 2024

(54) MASSAGER FOR SHOULDERS AND NECK

(71) Applicant: SKG Health Technologies Co., Ltd., Shenzhen (CN)

(72) Inventors: Wentao Liao, Shenzhen (CN); Xiaohui Peng, Shenzhen (CN); Lixin Huang, Shenzhen (CN)

(21) Appl. No.: 18/139,919

(22) Filed: Apr. 26, 2023

(51) Int. Cl. A61H 7/00

(52) U.S. Cl. CPC A61H 7/004; A61H 7/007

(57) ABSTRACT

A massager includes a wearing body for wearing on neck and a second massage head. The wearing body includes a cover shell and a driving mechanism installed thereon. The driving mechanism includes a transmission shaft rotatably installed on the cover shell, a second connecting piece eccentrically and rotatably connects the transmission shaft, a movable component movably connects the cover shell, and a swing component pivotally connects the cover shell. The movable component is located on a side of the transmission shaft. The second massage head connects the swing component. The second connecting piece pivotally connects the movable component. The movable component rotatably and slidably connects the swing component. The transmission shaft drives the swing component and the second massage head to swing through the second connecting piece and the movable component when the transmission shaft rotates, thereby forming massage actions on shoulders.

### FIELD

The subject matter herein generally relates to massagers, and more particularly, to a massager for shoulders and neck.

### BACKGROUND

In daily work, study, or leisure activities, people may often feel uncomfortable of cervical vertebra due to an improper posture for a long time. In severe cases, cervical spondylosis may even happen, which affects people's normal life. In order to alleviate the uncomfortable feeling of the cervical vertebra, various types of massagers for shoulders and neck have emerged on the market.

In related arts, a massager may include a main body for wearing on the neck of a human body and at least two massage heads configured to be located on both sides of the neck. The massage heads form massage actions on the shoulders and the neck of the human body by beating, thereby simulating the feeling of pounding one's back. However, a lot of noise may generate during the frequent beating process.

Furthermore, the massager may need at least two driving mechanisms to drive the at least two massage heads to operate, which may increase the cost of the massager. There are other types of massagers on the market that uses only a driving mechanism to simultaneously drive various massage heads to operate through a linkage structure. However, in order to simulate various massage techniques, the massage heads should be able to perform various motions such as self-rotation, revolution, eccentric rotation, swinging, and stretching. Therefore, the structure of the linkage structure is complex, and the structural reliability is poor.

Moreover, since the main body of such a massager needs to be equipped with various massage heads, the massager of this type generally has a large size and a heavy weight. When the massager is worn on the neck of the human body, the neck may feel a heavy weight. The shoulders and the neck may feel uncomfortable especially when the massager is used for a long time.

### BRIEF DESCRIPTION OF THE DRAWINGS

Implementations of the present technology will now be described, by way of embodiment, with reference to the attached figures. Obviously, the drawings are only some embodiments of the present application. For those of ordinary skill in the art, other drawings can be obtained based on these drawings without creative work.

FIG. 1 is a diagrammatic view of a massager for shoulders and neck according to an embodiment of the present application, wherein a first massage head of the massager is removed.

FIG. 2 is another diagrammatic view of the massager of FIG. 1.

FIG. 3 is another diagrammatic view of the massager of FIG. 1.

FIG. 4 is a cross-sectional view of the massager of FIG. 1.

FIG. 5 is another cross-sectional view of the massager of FIG. 1.

FIG. 6 is an enlarged view of portion A of FIG. 5.

FIG. 7 is a diagrammatic view of an eccentric transmission component of the massager.

FIG. 8 is another diagrammatic view of the eccentric transmission component of the massager.

FIG. 9 is yet another diagrammatic view of the eccentric transmission component of the massager.

FIG. 10 is a cross-sectional view of the eccentric transmission component of FIG. 9.

FIG. 11 is a cross-sectional view of a fixing cover of the eccentric transmission component of FIG. 9.

FIG. 12 is a diagrammatic view of a guide groove of the massager.

FIG. 13 is yet another diagrammatic view of the massager.

FIG. 14 is an enlarged view of part B of FIG. 13.

FIG. 15 is a diagrammatic view of a swing component of the massager.

FIG. 16 is a diagrammatic view showing the swing component of the massager after swinging.

FIG. 17 is yet another diagrammatic view of the massager.

FIG. 18 is an enlarged view of part C of FIG. 17.

FIG. 19 is a diagrammatic view showing a connection among a first connecting piece, a second connecting piece, and the eccentric transmission component of the massager.

FIG. 20 is an exploded view of the massager of FIG. 1, wherein a housing of the massager is removed.

FIG. 21 is another exploded view of the massager of FIG. 1.

FIG. 22 is yet another exploded view of the massager of FIG. 1.

FIG. 23 is a diagrammatic view of a driving component of the massager.

FIG. 24 is an enlarged view of part C of FIG. 23.

FIG. 25 is a diagrammatic view of a second shell of the massager.

FIG. 26 is yet another cross-sectional view of the massager.

FIG. 27 is another diagrammatic view of the second shell of the massager.

FIG. 28 is a diagrammatic view of a fixing plate of the massager.

FIG. 29 is yet another cross-section view of the massager.

FIG. 30 is a diagrammatic view of a first transmission component and a second transmission component of the massager.

### DETAILED DESCRIPTION

Implementations of the disclosure will now be described, by way of embodiments only, with reference to the drawings. The described embodiments are only some embodiments of the present application, rather than all the embodiments. Based on the disclosure of the present application, all other embodiments made by ordinary skill in the art without creative work are within the scope of the claims.

It should be understood that the terms “including” and “comprising” used in the specification and the accompanying claims indicate the presence of the described features, whole, step, operation, element, and/or assembly, but do not exclude the presence or addition of one or more other features, whole, step, operation, element, assembly, and/or the combination thereof.

It should also be understood that the terms used in the present application are only illustrative for the specific embodiments, but not intended to limit the present application. As used in the specification of the specification and the accompanying claims, the singular forms of “a”, “one”, and “the” are intended to include the plural forms unless other circumstances are clearly indicated.

It should also be further understood that the term “and/or” used in the specification of the present application and the accompanying claims refers to any combination or all possible combinations of one or more related items.

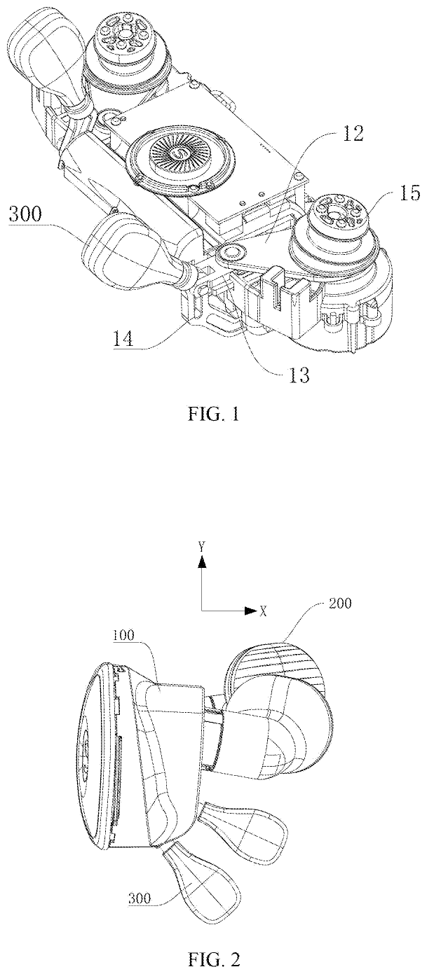

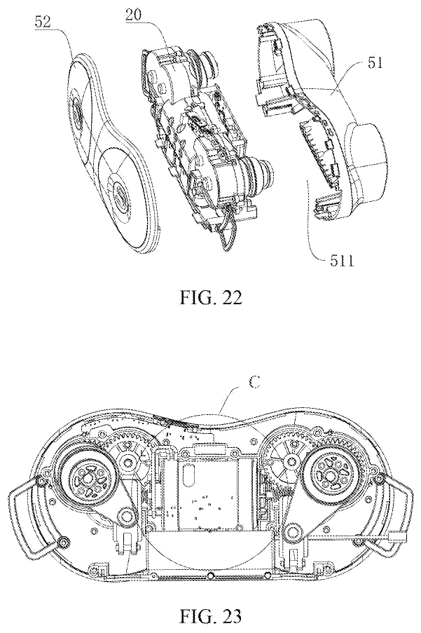

Referring to FIGS. 1 to 3, a massager for shoulders and neck is provided according to an embodiment of the present application. The massager includes a wearing body 100 for wearing on the neck and a second massage head 300. The wearing body 100 includes a cover shell 20 (shown in FIG. 22) and a driving mechanism 10 installed on the cover shell 20. The driving mechanism 10 includes a transmission shaft 11 rotatably installed on the cover shell 20, a second connecting piece 12 eccentrically and rotatably connected to the transmission shaft 11, a movable component 13 movably connected to the cover shell 20, and a swing component 14 pivotally connected to the cover shell 20. The movable component 13 is located on a side of the transmission shaft 11. The second massage head 300 is connected to the swing component 14. The second connecting piece 12 is pivotally connected to the movable component 13. The movable component 13 is rotatably and slidably connected to the swing component 14. Thus, when the transmission shaft 11 rotates, the second connecting piece 12 and the movable component 13 drive the swing component 14 and the second massage head 300 to swing, thereby forming massage actions on the shoulders.

In the above embodiment, the transmission shaft 11 and the second connecting piece 12 are eccentrically and rotatably connected to each other, thereby enabling the second connecting piece 12 to swing eccentrically. The second connecting piece 12 drives the movable component 13 that is movably connected to the cover shell 20 to move. The movable component 13 and the swing component 14 are rotatably and slidably connected to each other. The movable component 13 drives the swing component 14 that is pivotally connected to the cover shell 20 to swing, thereby allowing the second massage head 300 that is connected to the swing component 14 to forming massage actions on the shoulders in a swinging manner. Compared to the massage actions of beating, the massage actions on the shoulders in the swinging manner generate no noise. Silent massage with a good user experience can be realized.

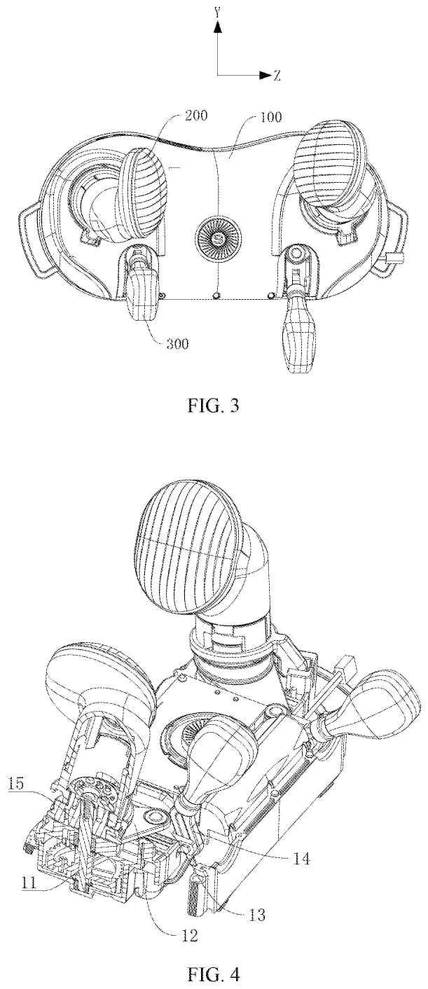

As shown in the coordinate systems in FIG. 2 or 3, X axis represents a thickness direction of the wearing body 100 or the cover shell 20, Y axis represents a width direction of the wearing body 100 or the cover shell 20, and Z axis represents a length direction of the wearing body 100 or the cover shell 20.

Referring to FIGS. 2 and 3, in at least one embodiment, the massager further includes a first massage head 200. The first massage head 200 is connected to the transmission shaft 11. The first massage head 200 and the second massage head 300 are spaced from each other in the width direction of the cover shell 20. The first massage head 200 and the second massage head 300 are further used to cooperatively squeeze and pinch the shoulders. Wherein, the first massage head 200 acts on and massages the neck of the human body, and the second massage head 300 acts on and massages the shoulders of the human body. When the driving mechanism 10 drives the first massage head 200 and the second massage head 300 to work, the first massage head 200 and the second massage head 300 move toward each other in the width direction of the wearing body 100 and cooperatively pinch the shoulders.

Referring to FIGS. 4 to 10, in at least one embodiment, the driving mechanism 10 further includes an eccentric transmission component 15 installed on the transmission shaft 11. The eccentric transmission component 15 includes an eccentric transmission portion 151. The transmission shaft 11 is located at an eccentric position of the eccentric transmission portion 151. The second connecting piece 12 is rotatably sleeved on the eccentric transmission portion 151, so that the second connecting piece 12 is eccentrically and rotatably connected to the transmission shaft 11.

Referring to FIGS. 6 to 10, in at least one embodiment, the eccentric transmission component 15 includes a rotation driving portion 153, a shaft installing hole 152, and the eccentric transmission portion 151. The shaft installing hole 152 is defined in the rotation driving portion 153, and the shaft installing hole 152 is used to install the transmission shaft 11 therein. The eccentric transmission portion 151 protrudes from the rotation driving portion 153. The shaft installing hole 152 is located at the eccentric position of the eccentric transmission portion 151. Since the eccentric transmission portion 151 is located at the eccentric position relative to the transmission shaft 11, the eccentric transmission portion 151 rotates eccentrically when the rotation driving portion 153 rotates. In addition, the second connecting piece 12 defines a through hole (not shown). The second connecting piece 12 is sleeved on the eccentric transmission portion 151 through the through hole. Thus, the second connecting piece 12 can rotate relative to the eccentric transmission portion 151. The transmission shaft 11 drives the eccentric transmission portion 151 to perform an eccentric motion, and the second connecting piece 12 is sleeved on the eccentric transmission portion 151, therefore, the second connecting piece 12 and the eccentric transmission portion 151 can rotate relative to each other to realize an eccentrical rotation between the second connecting piece 12 and the transmission shaft 11. Thus, the eccentric transmission portion 151 rotates eccentrically when the transmission shaft 11 rotates, thereby driving the second connecting piece 12 to swing eccentrically.

The eccentric transmission component 15 further includes a swing driving surface 154 inclined with an axis L1 of the shaft installing hole 152. The rotation driving portion 153 protrudes from the swing driving surface 154. In the above embodiment, when the eccentric transmission component 15 rotates, the swinging action can be achieved by the swing driving surface 154 and the rotation driving portion 153. The eccentric swinging action can also be achieved by the eccentric transmission portion 151. That is, the swinging and eccentric swinging actions can both be achieved through only one eccentric transmission component 15 without multiple components to cooperate. Since only one eccentric transmission component 15 is needed, excessive components are not needed, so that the massager can have a simple structure, high reliability, and lower cost.

Referring to FIG. 9, in at least one embodiment, the eccentric transmission component 15 further includes a swinging rotating surface 155 opposite to the swing driving surface 154. The eccentric transmission portion 151 protrudes from the swinging rotating surface 155. That is, the eccentric transmission portion 151 is opposite to the rotation driving portion 153. The rotation driving portion 153 is located on one side of the swing driving surface 154, and the eccentric transmission portion 151 is located on one side of the swinging rotating surface 155. When one connecting piece (i.e., the first connecting piece 19 mentioned in the following paragraphs) transmits force to the rotation driving portion 153 on one side of the swing driving surface 154, and another connecting piece (i.e., the second connecting piece 12 mentioned in the following paragraphs) transmits force to the eccentric transmission portion 151 on one side of the swinging rotating surface 155, the two force transmission actions are achieved on both sides without interference, thereby ensuring the reliability of the transmission.

In at least one embodiment, the swing driving surface 154 and the swinging rotating surface 155 have a maximum distance and a minimum distance in the extension direction of the axis L1 of the shaft installing hole 152. The distance gradually increases from a position corresponding to the minimum distance to another position corresponding to the maximum distance, so that the swing driving surface 154 is inclined with the axis L1 of the shaft installing hole 152. In at least one embodiment, the swing driving surface 154 is perpendicular to the axis L1 of the shaft installing hole 152. The swing driving surface 114 is a horizontal surface, and the swing driving surface 154 is an inclined surface. In other embodiments, the swinging rotating surface 155 may not be a horizontal surface, and it only needs that there is a changing distance between the swinging rotating surface 155 and the swing driving surface 154. When the distance between the two surfaces gradually changes from small to large or from large to small, the swing driving surface 154 can be inclined with the axis L1 of the shaft installing hole 152.

Referring to FIG. 9, in at least one embodiment, an outer periphery of the rotation driving portion 153 is a cylindrical surface, and an axis L2 of the outer periphery of the rotation driving portion 153 is perpendicular to the swing driving surface 154. Since the outer periphery of the rotation driving portion 153 is a cylindrical surface, the first connecting piece 19 can be rotatably sleeved on the rotation driving portion 153. When the eccentric transmission component 15 rotates, the first connecting piece 19 can rotate relative to the rotation driving portion 153. Since the axis L2 of the outer periphery of the rotation driving portion 153 is perpendicular to the swing driving surface 154 (i.e., the rotation driving portion 153 protrudes vertically from the swing driving surface 154), the first connecting piece 19 can be vertically inserted in the rotation driving portion 153, thereby allowing the swinging process to be more stable and avoiding shaking during swinging.

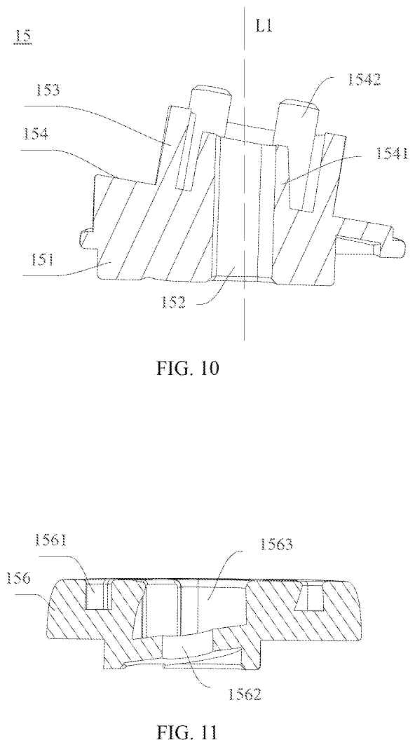

Referring to FIG. 10, in at least one embodiment, the shaft installing hole 152 further penetrates through the rotation driving portion 153. When the transmission shaft 11 rotates, the transmission shaft 11 drives the eccentric transmission component 15 to rotate. Since the shaft installing hole 152 penetrates through the rotation driving portion 153, the transmission shaft 11 can also penetrate into the rotation driving portion 153. When the eccentric transmission component 15 rotates, the stability of the rotation driving portion 153 can be ensured. Moreover, the transmission shaft 11 is conveniently to be fixed to the eccentric transmission component 15 through fasteners, avoiding slipping between the transmission shaft 11 and the eccentric transmission component 15.

Referring to FIGS. 8 and 10, in at least one embodiment, the rotation driving portion 153 is annular. A convex portion 1541 further protrudes from the swing driving surface 154, and is located in the inner side of the rotation driving portion 153. The shaft installing hole 152 penetrates the convex portion 1541. Since the rotation driving portion 153 is annular, thereby allowing the first connecting piece 19 to be sleeved on and rotate with respect to the rotation driving portion 153. In the inner side of the annular rotation driving portion 153, the convex portion 1541 protrudes from the swing driving surface 154 by a certain height. The shaft installing hole 152 penetrates into the convex portion 1541, which facilitating the fastener to fix to the transmission shaft 11 in the shaft installing hole 152.

Referring to FIG. 8, in at least one embodiment, at least one post 1542 each having a screw hole further protrudes from the swing driving surface 154 and is located in the inner side of the rotation driving portion 153. In the embodiment, since each post 1542 is arranged in the inner side of the annular rotation driving portion 153, the post 1542 is conveniently fixed to an external component.

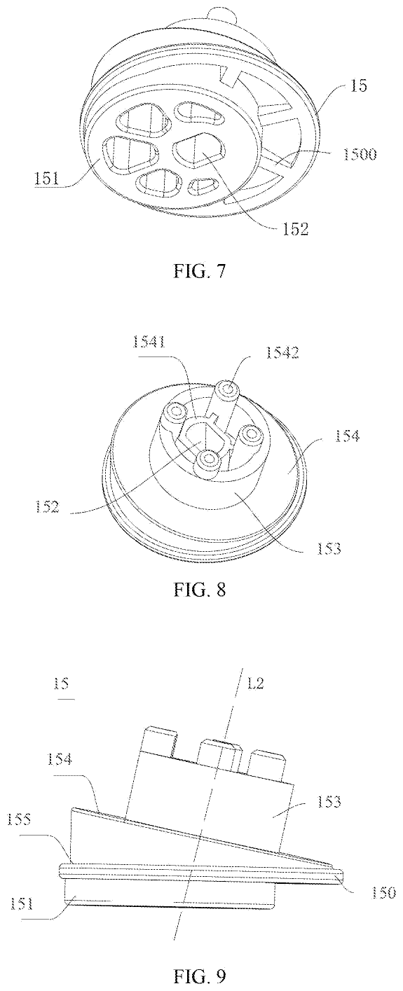

Referring to FIG. 7, in at least one embodiment, an outer periphery of the eccentric transmission portion 151 is a cylindrical surface. Since the outer periphery of the eccentric transmission portion 151 is a cylindrical surface, the first connection piece 19 is facilitated to be rotatably sleeved on the cylindrical surface. Thus, the eccentric transmission portion 151 can rotate relative to the connection piece. Furthermore, since the eccentric transmission portion 151 can swing eccentrically, the eccentric transmission portion 151 can drive the first connection piece 19 to swing eccentrically.

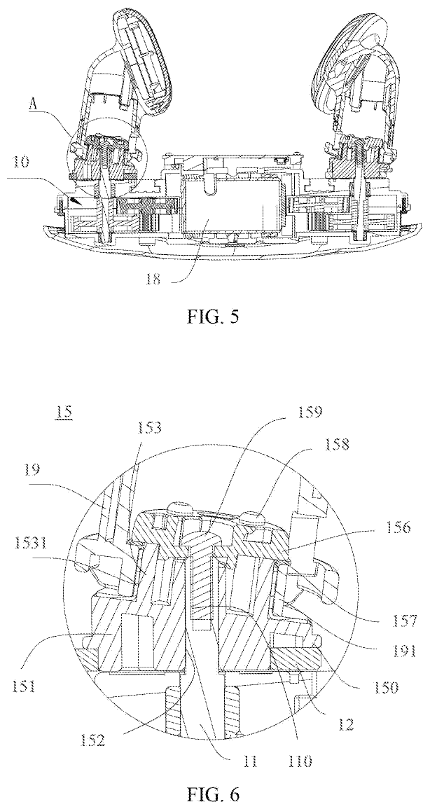

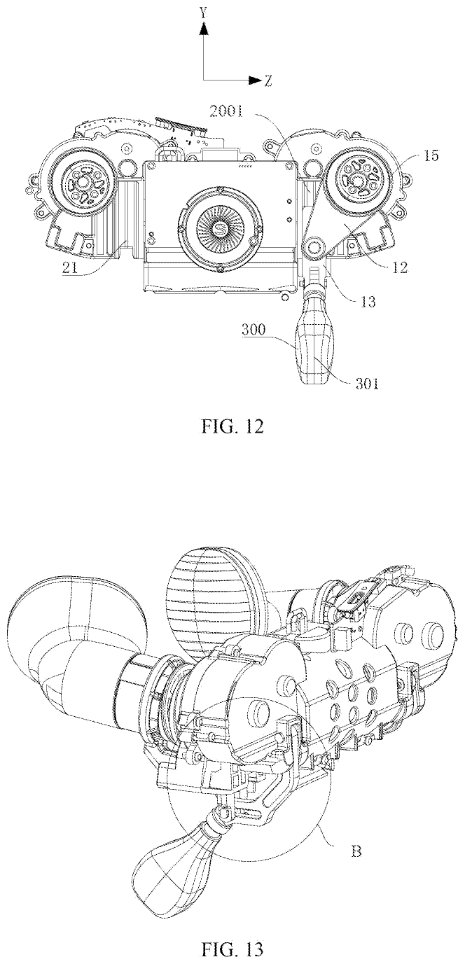

Referring to FIGS. 5 and 12, the driving mechanism 10 further includes a driving component 18 and the above-mentioned first connecting piece 19. The driving component 18 is used to drive the transmission shaft 11 to rotate. The first massage head 200 is connected to the first connecting piece 19, and the second massage head 300 is connected to the second connecting piece 12. The first connecting piece 19 is rotatably connected to the rotation driving portion 153, and is resisted against the swing driving surface 154. Thus, the swing driving surface 154 can drive the first connecting piece 19 to swing when the transmission shaft 11 drives the eccentric transmission component 15 to rotate. The second connecting piece 12 is rotatably sleeved on the eccentric transmission portion 151. Thus, the eccentric transmission portion 151 can drive the second connecting piece 12 to swing eccentrically when the transmission shaft 11 drives the eccentric transmission component 15 to rotate. In at least one embodiment, the driving mechanism 10 further includes a shaft sleeve 1531. The shaft sleeve 1531 is sleeved on the rotation driving portion 153, and the first connecting piece 19 is sleeved on the shaft sleeve 1531.

In the above embodiment, the swing driving surface 154 and the rotation driving portion 153 of the eccentric transmission component 15 are used to drive the first connecting piece 19. The eccentric transmission portion 151 of the eccentric transmission component 15 is used to drive the second connecting piece 12. When the eccentric transmission component 15 rotates, the first connecting piece 19 can swing and drive the first massage head 200 to move, and the second connecting piece 12 can swing eccentrically and drive the second massage head 300 to move. Therefore, both of the swing motion and eccentric swing motion can be achieved by only one eccentric transmission component 15. It has no need to arrange multiple components to cooperate. Excessive components are not needed, so that the massager can have a simple structure, high reliability, and lower cost.

Referring to FIGS. 6 and 11, in at least one embodiment, the eccentric transmission component 15 further includes a fixing cover 156 and an outer flange gasket 157. The fixing cover 156 is fixed to an end surface of the rotation driving portion 153 away from the swing driving surface 154. The edge of the fixing cover 156 protrudes from the outer periphery of the rotation driving portion 153. The first connecting piece 19 is barrel-shaped. The first connecting piece 19 is rotatably sleeved on the rotation driving portion 153, and is resisted against the swing driving surface 154. The first connecting piece 19 includes an inner flange 191. The outer flange gasket 157 is sleeved on the rotation driving portion 153, and is located between the inner flange 191 and the edge of the fixing cover 156.

In at least one embodiment, the first connecting piece 19 is barrel-shaped with an opening. The first connecting piece 19 is rotatably sleeved on the outer periphery of the rotation driving portion 153. The opening of the first connecting piece 19 is resisted against the swing driving surface 154. A portion of the first connecting piece 19 is fixed to or limited by the outside, so that the first connecting piece 19 does not rotate together with the rotation driving portion 153. Thus, a relative rotation is achieved between the first connecting piece 19 and the rotation driving portion 153. Therefore, when the eccentric transmission component 15 rotates, since the first connecting piece 19 does not rotate together with the rotation driving portion 153, the first connecting piece 19 is continuously pushed up and tilted by the swing driving surface 154 that is rotating, thereby achieving swinging. The end surface of the rotation driving portion 153 is fixed with the fixing cover 156, and the outer contour of the fixing cover 156 is larger than the outer contour of the rotation driving portion 153. Thus, the fixing cover 156 protrudes from the edge of the rotation driving portion 153. By setting the outer flange gasket 157 on the outer periphery of the rotation driving portion 153, and the inner flange 191 protrudes from the inner wall of the first connecting piece 19, when the first connecting piece 19 is sleeved on the rotation driving portion 153, the outer flange gasket 157 is located between the fixing cover 156 and the edge of the rotation driving portion 153 that is protrudes from the inner flange 191. The edge of the fixing cover 156 is resisted against the outer flange gasket 157, and the outer flange gasket 157 is resisted against the inner flange 191. When the eccentric transmission component 15 rotates, the first connecting piece 19 swings. If the eccentric transmission component 15 rotates too fast, the first connecting piece 19 may be pushed by and separated from the swing driving surface 154. By setting the outer flange gasket 157 to resist against the inner flange 191, the position of the first connecting piece 19 is limited, thereby preventing the first connecting piece 19 from separating from the rotation driving portion 153. In other embodiments, the outer flange gasket 157 may also be fixed to the rotation driving portion 153 by the fixing cover 156.

Referring to FIG. 6, in at least one embodiment, at least one first fixing hole 1561 is defined in the fixing cover 156 and corresponds to the at least one post 1542. The eccentric transmission component 15 further includes at least one first fastener 158. Each first fastener 158 passes through one first fixing hole 1561 and is fixed to the corresponding post 1542. In at least one embodiment, the first fastener 158 is a screw rod. Four posts 1542 are included, and the eccentric transmission component 15 includes four screw rods accordingly. The fixing cover 156 is fixed to the end surface of the rotation driving portion 153 through the engagement between the screw rods and the posts 1542.

Referring to FIGS. 6 and 11, in at least one embodiment, the shaft installing hole 152 extends through the end surface of the rotation driving portion 153 away from the swing driving surface 154. The transmission shaft 11 defines a shaft hole 110. The fixing cover 156 defines a second fixing hole 1562 corresponding to the shaft hole 110. The eccentric transmission component 15 further includes a second fastener 159. The second fastener 159 passes through the second fixing hole 1562 and is fixed to the shaft hole 110. In the above embodiment, in order to avoid slipping between the transmission shaft 11 and the eccentric transmission component 15, the shaft hole 110 is defined in the transmission shaft 11, and the second fastener 159 passes through the second fixing hole 1562 on the fixing cover 156 and is fastened to the shaft hole 110. Thus, the fixing cover 156 can be pressed onto the end surface of the rotation driving portion 153, thereby fixing the fixing cover 156, the eccentric transmission component 15, and the transmission shaft 11 together. When the eccentric transmission component 15 rotates with the transmission shaft 11, the slipping between the transmission shaft 11 and the eccentric transmission component 15 is avoided.

Furthermore, the outer periphery of the transmission shaft 11 is at least partially flattened, and the shape of the shaft installing hole 152 matches the shape of the transmission shaft 11. That is, the shape of transmission shaft 11 is non-circular, and a portion of the outer periphery is flat. For example, two opposite sides on the outer periphery of transmission shaft 11 are flattened, and the shape of the shaft installing hole 152 of the eccentric transmission component 15 is the same as that of the transmission shaft 11. Thus, there is a plane of contact when transmission shaft 11 rotates in the shaft installing hole 152, which can avoid relative sliding.

Referring to FIG. 11, in at least one embodiment, the fixing cover 156 is recessed towards the rotation driving portion 153 to form a groove 1563. The second fixing hole 1562 is defined in the bottom surface of the groove 1563. The bottom surface of the groove 1563 is inclined. Since to the swing driving surface 154 is also inclined, the rotation driving portion 153 protruding from the swing driving surface 154 is also inclined. When the fixing cover 156 is fixed to the end surface of the rotation driving portion 153, the first fastener 158 and the second fastener 159 need to be installed inclinedly. For example, when installing the screw rod, since the hole is inclined, the screw rod is easily deviated, and it difficult to apply force on the screw rod. Therefore, in the above embodiment, the second fixing hole 1562 is set to be inclined, and the second fixing hole 1562 is defined in the bottom surface of the groove 1563. The bottom surface is inclined relative to the swing driving surface 154, but is horizontal relative to the swinging rotating surface 155. Therefore, the screw rod can be vertically screwed into the second fixing hole 1562. Thus, the screw rod is conveniently installed and is not easily deviated.

Referring to FIG. 6, in at least one embodiment, the eccentric transmission component 15 further includes an annular support portion 150. The annular support portion 150 protrudes from the outer periphery of the swing driving surface 154. The annular support portion 150 is in contact with the second connecting piece 12. The annular support portion 150 is equivalent to an outer flange of the swing driving surface 154. When the second connecting piece 12 is sleeved on the eccentric transmission portion 151, the annular support portion 150 is resisted against the end surface of the second connecting piece 12, so that the second connecting piece 12 can support the annular support portion 150. On the one hand, the annular support portion 150 can limit the position of the second connecting piece 12 that is inserted into the eccentric transmission portion 151. On the other hand, since the annular support portion 150 is resisted against the second connecting piece 12, the annular support portion 150 can support the entire eccentric transmission component 15.

Referring to FIG. 7, in at least one embodiment, the eccentric transmission component 15 further includes at least one first reinforcing rib 1500. One end of the first reinforcing rib 1500 is connected to the annular support portion 150, and another end of the reinforcing rib 1500 is connected to the eccentric transmission portion 151. The annular support portion 150 is connected to the eccentric transmission portion 151 through the first reinforcing ribs 116, which improves the structural strength of the annular support portion 150 and the entire eccentric transmission component 15.

Referring to FIG. 12, in an embodiment, the movable component 13 as a whole is in a shape of a slider. A guide groove 2001 is defined in the cover shell 20. The movable component 13 slides in the guide groove 2001, so that the movable component 13 is movably connected to the cover shell 20. In at least one embodiment, the guide groove 2001 is defined in a surface of the cover shell 20 facing the second massage head 300. The guide groove 2001 extends in the width direction of the wearing body 100, and is adjacent to the eccentric transmission component 15. The movable component 13 is slidably received in the guide groove 2001, which facilitating the second connecting piece 12 that is sleeved on the eccentric transmission component 15 to drive the movable component 13 to slide back and forth in the guide groove 2001. On the one hand, the movable component 13 is used to be pivotally connected to the second connecting piece 12. When the second connecting piece 12 swings eccentrically, the second connecting piece 12 can drive the movable component 13 to slide along the guide groove 2001. On the other hand, the movable component 13 is used to be rotatably and slidably connected to the swing component 14. When the movable component 13 slides in the guide groove 2001, the movable component 13 drives the swing component 14 to swing. Furthermore, the guide groove 2001 is arranged in the width direction of the wearing body 100, and the swing component 14 is connected to the second massage head 300. Thus, the swing component 14 and the second massage head 300 are driven to swing in the width direction of the wearing body 100, thereby cooperatively pinching the shoulders with the first massage head 200. In addition, by defining the guide groove 2001 on the surface of cover shell 20, the surface space of the cover shell 20 can be fully utilized, and the installation space inside the cover shell 20 can be saved.

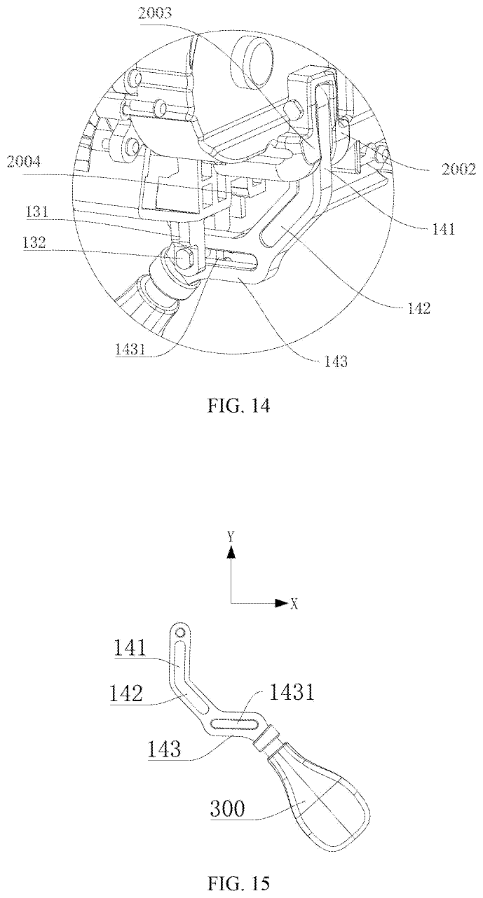

Referring to FIGS. 13 and 14, in at least one embodiment, one of the swing component 14 and the movable component 13 has a sliding groove 1431 being strip-shaped. The other one of the swing component 14 and the movable component 13 has a sliding rod 132. The sliding rod 132 is rotatably and slidably connected in the sliding groove 1431, so that the movable component 13 is rotatably connected to the swing component 14. The embodiment achieves the rotatable and slidable connection between the swing component 14 and the movable component 13 by arranging the sliding rod 132 to slide in the sliding groove 1431. The sliding groove 1431 can be arranged on the swing component 14, the sliding rod 132 can be arranged on the movable component 13. Or, the sliding groove 1431 can be arranged on the movable component 13, and the sliding rod 132 can be arranged on the swing component 14, which are not limited in the present application. When the transmission shaft 11 rotates, the second connecting piece 12 swings eccentrically, which drives the movable component 13 to slide in the sliding groove 1431. The movable component 13 slides in the sliding groove 1431 of the swing component 14 through the sliding rod 132, thereby driving the swing component 14 and the second massage head 300 to swing.

Referring to FIG. 14, in at least one embodiment, an end of the movable component 13 includes two connecting ears 131. The movable component 13 includes the sliding rod 132. The swing component 14 defines the sliding groove 1431. The sliding rod 132 passes through the sliding groove 1431 and is then fixed between the two connecting ears 131. The sliding rod 132 drives the swing component 14 to rotate when the sliding groove 1431 slides, so that the swing component 14 swings in the width direction of the cover shell 20. In at least one embodiment, one end of the sliding groove 1431 is closed, and another end of the sliding groove 1431 is opened. The two connecting ears 131 are arranged on the end of the movable component 13 that is adjacent to the open end of the sliding groove 1431. The sliding rod 132 passes through the two connecting ears 131. The sliding rod 132 also passes through the sliding groove 1431 of the swing component 14. Therefore, when the movable component 13 slides in the sliding groove 1431, the sliding rod 132 also slides in the sliding groove 1431 to drive the swing component 14 to swing.

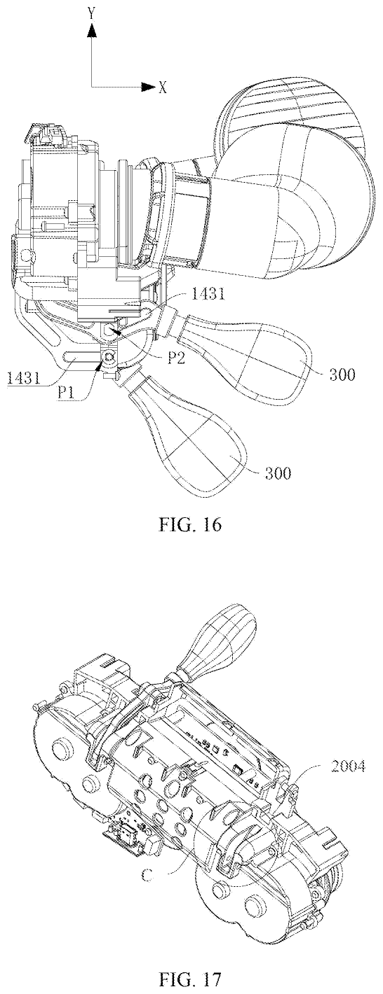

Referring to FIG. 16, in at least one embodiment, the sliding rod 132 in the sliding groove 1431 has a first position P1 near the second massage head 300 and a second position P2 away from the second massage head 300. When the sliding rod 132 slides to the first position P1, the third arm segment 143 is away from the cover shell 20 in the width direction of the cover shell 20. When the sliding rod 132 slides to the second position P2, the third arm segment 143 is toward the cover shell 20 in the width direction of the cover shell 20. The first position P1 is the position of the open end of the sliding groove 1431 being strip-shaped, and the second position P2 is the position of the closed end of the sliding groove 1431. That is, when the sliding rod 132 slides to the first position P1, the second massage head 300 swings toward the first massage head 200, so that the first massage head 200 and the second massage head 300 cooperatively squeeze the shoulders. When the sliding rod 132 slides to the second position P2, the second massage head 300 swings away from the first massage head 200, thereby releasing the shoulder muscles.

Referring to FIGS. 14 and 15, in at least one embodiment, the swing component 14 is in a shape consisting of multiple segments. The swing component 14 includes a first arm segment 141, a second arm segment 142, and a third arm segment 143. One end of the first arm segment 141 is pivotally connected to a side of the cover shell 20 away from the second massage head 300. One end of the second arm segment 142 is connected to another end of the first arm segment 141. The second arm segment 142 further bypasses the surface of the cover shell 20 and extends in the thickness direction of the cover shell 20. Another end of the second arm segment 142 is connected to one end of the third arm segment 143, and another end of the third arm segment 143 is connected to the second massage head 300. The sliding groove 1431 is defined in the third arm segment 143. In at least one embodiment, the swing component 14 is located outside the cover shell 20. The swing component 14 has a structure consisting of three segments, and each of the three arm segments is in a shape of a thin rod. The swing component 14 extends from one side of the cover shell 20 to the other side of the cover shell 20, and is arranged along the surface of the cover shell 20. By setting the swing component 14 to include three arm segments, the swing component 14 can match the surface of the cover shell 20 better, so that the whole swing component 14 can have smaller swing amplitude and swing more stably.

In at least one embodiment, the first arm segment 141, the second arm segment 142, and the third arm segment 143 are integrally formed. The integrally formed arm segments can increase the structural strength.

In other embodiments, the first arm segment 141, the second arm segment 142, the third arm segment 143, and the second massage head 300 are integrally formed. When the three arm segments and the second massage head 300 are integrally formed, the structural strength can be increased on the one hand, and there is no need to install the second massage head 300 on the other hand, that is, the installation step is omitted.

Referring to FIGS. 12 and 15, furthermore, the second massage head 300 is a flat inverted cone. One end of the inverted cone is connected to the third arm segment 143. The overall shape of the inverted cone is flat. A flat and slightly round surface is arranged on the periphery of the inverted cone. Thus, when applied to the shoulders, the second massage head 300 can push up the shoulder muscles and squeeze the shoulder muscles together with the first massage head 200. In at least one embodiment, in the length direction of the wearing body 100, the second massage head 300 includes a side facing the neck and another side away from the neck. The two sides are opposite to each other and are flat. A pushing side 301 is connected between the two sides for pushing the shoulder. The pushing side 301 is also flat. Since the whole second massage head 300 is an inverted cone, the second massage head 300 has edges at its turning position. When the second massage head 300 and the first massage head 200 cooperatively squeezes the shoulders, the turning position of the inverted cone can push up the shoulder muscles to facilitate the squeezing process.

Referring to FIG. 14, in at least one embodiment, in order to maintain the stability of the swing component 14 during swinging, the cover shell 20 includes a first limit arm 2002 and a second limit arm 2003 both on one side of the cover shell 20 away from the second massage head 300. The first arm segment 141 extends into a space defined by the first limit arm 2002 and the second limit arm 2003. One end of the first arm segment 141 is pivotally connected in the space between the first limit arm 2002 and the second limit arm 2003. Since the cover shell 20 includes the two limit arms and the two limit arms are connected to the first arm segment 141 through a rotating shaft, the first arm segment 141 can rotate and swing between the two limit arms. The first arm segment 141 is blocked between the two limit arms, so that the first arm segment 141 is limited by two limit arms when the first arm segment 141 swings. Thus, the shaking of the first arm segment 141 is avoided. The swinging process is more stable, and the reliability is improved.

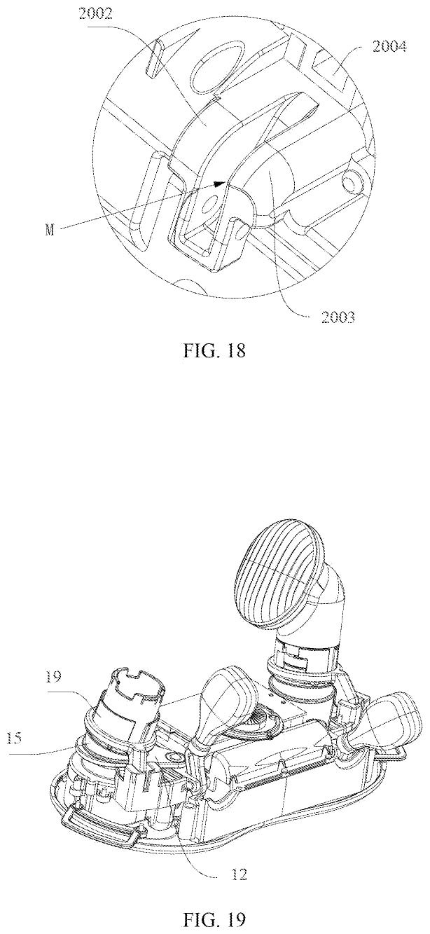

Referring to FIGS. 17 and 18, furthermore, each of the first limit arm 2002 and the second limit arm 2003 is formed in the width direction of the cover shell 20, and further extend toward the thickness direction of the cover shell 20. Thus, the first limit arm 2002 and the second limit arm 2003 cooperatively define a swinging space M in the thickness direction of the cover shell 20, and the first arm segment 141 can swing in the swinging space M. Since the first arm segment 141 needs to swing in the thickness direction of cover shell 20, the swing amplitude is relatively large. Therefore, the two limit arms are arranged to extend toward the thickness direction of cover shell 20, and the two limit arms cooperatively define the swinging space M in the thickness and width directions of cover shell 20. When the first arm segment 141 swings in the thickness direction, the first arm segment 141 swings in the swinging space M and can be limited by two limit arms, thereby allowing the swinging process to be more stable.

Referring to FIG. 14, the first arm segment 141 does not protrude from the first limit arm 2002 and the second limit arm 2003 in the thickness direction of the cover shell 20 when swinging in the swinging space M. In order to avoid excessive swing amplitude of the first arm segment 141, the first arm segment 141 is limited to be swing in the swinging space M and cannot swing beyond the limit arms. Therefore, the swing amplitude of the first arm segment 141 needs to be limited, so that the first arm segment 141 cannot protrude from the two limit arms in the thickness direction of the cover shell 20. Thus, the first arm segment 141 is prevented from pushing against the wearing body 100 in the thickness direction of the cover shell 20.

Referring to FIGS. 17 and 18, in addition, the cover shell 20 further defines a notch 2004 in the thickness direction. The notch 2004 is used to receive the second arm segment 142. Since the second arm segment 142 bypasses the surface of the cover shell 20 and extends in the thickness direction, the second arm segment 142 may collide with the surface of the cover shell 20 when swinging. Therefore, the notch 2004 is defined in the surface of the cover shell 20. When the second arm segment 142 swings, the second arm segment 142 can be received in the notch 2004 to avoid collisions.

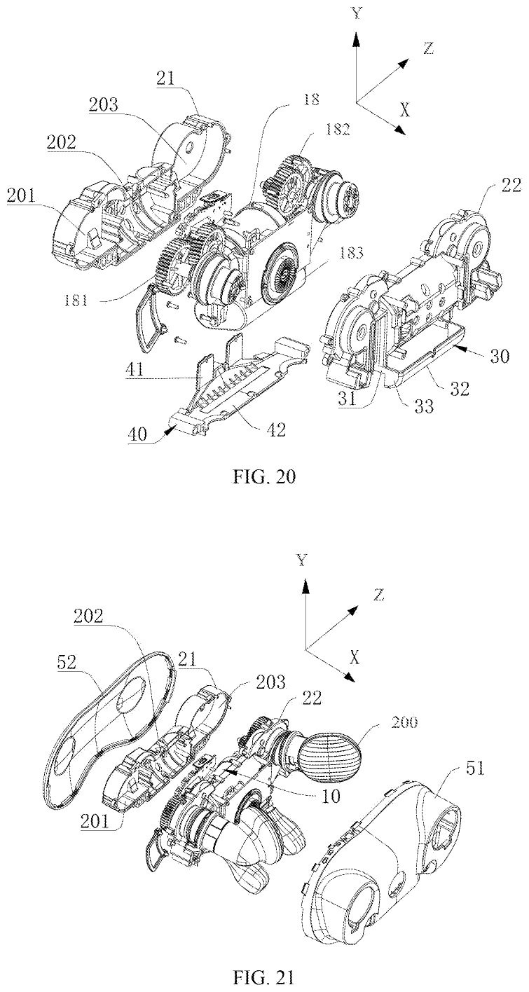

Referring to FIGS. 20 to 22, in at least one embodiment, the wearing body 100 further includes a housing 50 and a battery installation shell 30. The driving mechanism 10 further includes a first transmission component 181, a second transmission component 182, and a battery 183. Each of the first transmission component 181 and the second transmission component 182 is connected to the driving component 18. The battery 183 is used to supply electric power to the driving component 18. The cover shell 20 is used to receive the driving mechanism 10 therein, and includes a first shell 21 and a second shell 22. The second shell 22 is connected to the first shell 21 to form a receiving space. In the length direction of the cover shell 20, the receiving space defines a first receiving chamber 201, a second receiving chamber 202, and a third receiving chamber 203 are arranged so that the first receiving chamber 201 and the third receiving chamber 203. The first receiving chamber 201 and the third receiving chamber 203 are located on both sides of the second receiving chamber 202. The battery installation shell 30 is connected to at least one of the first shell 21 and the second shell 22. The battery installation shell 30 is located in the width direction of the cover shell 20, and adjacent to the second receiving chamber 202. The first transmission component 181 is received in the first receiving chamber 201. The driving component 18 is received in the second receiving chamber 202. The second transmission component 182 is received in the third receiving chamber 203. The battery 183 is received in the battery installation shell 30.

In this embodiment, the first shell 21 and the second shell 22 cooperatively define the first receiving chamber 201, the second receiving chamber 202, and the third receiving chamber 203. The second receiving chamber 202 is located between the first receiving chamber 201 and the third receiving chamber 203 in the length direction. A motor (i.e., the motor 180 mentioned in the following paragraphs) of the driving component 18 is received in the second receiving chamber 202 located in the middle position. The first transmission component 181 and the second transmission component 182 are respectively received in the first and the third receiving chambers 201 and 203 located on both sides. The battery 183 is received in the battery installation shell 30. The battery installation shell 30 is arranged in the width direction of the cover shell 20, namely, the battery installation shell 30 is located on one side of the cover shell 20. The battery installation shell 30 is adjacent to the second receiving chamber 202, namely, the battery installation shell 30 is located near the middle position. Therefore, the entire driving mechanism 10 is reasonably received in the cover shell 20 through the above structural design, preventing too much space from being occupied in the length or the width direction. The overall size and weight are small. When the massager is worn on the neck, the use will not sense heavy, which improves the user experience.

The cover shell 20 is received in the housing 50. Each of the first massage head 200 and the second massage head 300 protrude from the housing 50. In at least one embodiment, the massager includes four massage heads, namely, two first massage head 200 and two second massager heads 300. One of the first massage head 200 located at the left side and one of the second massager heads 300 located at the left side are left massage heads. The other one of the first massage head 200 located at the right side and the other one of the second massager heads 300 located at the right side are right massage heads. Both of the left massage heads are connected to the first transmission component 181, and both of the right massage heads are connected to the second transmission component 182. When the driving component 18 drives the first transmission component 181 and the second transmission component 182, the two left massage heads are driven by the first transmission component 181 to move, and the two right massage heads are driven by the second transmission component 182 to move. That is, the driving component 18 can drive the four massage heads to simultaneously move.

Referring to FIGS. 20, 23 and 24, in at least one embodiment, the driving component 18 includes a motor 180 with two output shafts. Each of the first transmission component 181 and the second transmission component 182 is a gear group. The motor 180 is received in the second receiving chamber 202 in the middle. The gear groups are located in the first receiving chamber 201 and the third receiving chamber 203 on both sides. The output shafts of the motor 180 are connected to the gear groups located on both sides of the motor 180. The gear group in the first receiving chamber 201 is connected to the left massage heads, and the gear group in the third receiving chamber 203 is connected to the right massage heads. The gear group has a linkage structure that can drive two left massage heads or two right massage heads to simultaneously move. Therefore, when driven by output shafts, the four massage heads can simultaneously move.

In at least one embodiment, the battery installation shell 30 is integrally connected to the first shell 21 or the second shell 22.

It should be noted that the battery installation shell 30 can be an independent component or a component integrally formed with the first shell 21 or the second shell 22. Therefore, the battery installation shell 30 can be integrally formed with or separated from the first shell 21/second shell 22. In detail, when the battery installation shell 30 is an independent component, the battery installation shell 30 can be separately connected to the first shell 21, to the second shell 22, or to both of the first shell 21 and the second shell 22. When the battery installation shell 30 is an integral component, the battery installation shell 30 can also be integrally connected to the first shell 21 or the second shell 22. In at least one embodiment, the battery installation shell 30 is separately connected to the second shell 22 or integrally formed with the second shell 22. The battery installation shell 30 integrally formed with the second shell 22 can increase the structural strength of the shell, save the assembly step, and make the installation process more convenient.

Referring to FIG. 20, in at least one embodiment, the wearing body 100 further includes a battery fixing base 40. The battery fixing base 40 is detachably connected to the first shell 21. The battery fixing base 40 is located in the width direction of the cover shell 20 and adjacent to the second receiving chamber 202. The battery fixing base 40 and the battery installation shell 30 cooperatively define a space for receiving the battery 183.

In at least one embodiment, the battery installation shell 30 is integrally formed with or separated connected to the second shell 22. The battery fixing base 40 is detachably connected (separated connected) to the first shell 21. The battery fixing base 40 is arranged in the same position as the battery installation shell 30. When the battery fixing base 40 is assembled with the battery installation shell 30, the battery fixing base 40 and the battery installation shell 30 face each other and cooperatively surround the battery 183. The battery 183 is limited with the battery fixing base 40 and the battery installation shell 30. After the battery fixing base 40 is removed from the battery installation shell 30, the battery 183 can be easily removed from the battery installation shell 30 for replacement since the battery installation shell 30 has been opened. Therefore, by setting the battery fixing base 40 to be detachably connected to the first shell 21, the battery 183 can be replaced, which facilitating the installation and disassembly of the battery 183.

Referring to FIG. 20, in at least one embodiment, the battery fixing base 40 includes at least one first connecting arm 41 and a support portion 42. One end of each first connecting arm 41 is connected to the support portion 42, and another end of the first connecting arm 41 is connected to the first shell 21. The battery installation shell 30 includes at least one second connecting arm 31 and a curved blocking plate 32. One end of each second connecting arm 31 is connected to the second shell 22, and another end of the second connecting arm 31 is connected to the curved blocking plate 32. The second connecting arm 31 extends toward the thickness direction of the cover shell 20. The battery 183 is located on the support portion 42. The first connecting arm 41 and the curved blocking plate 32 are located on both sides of the battery 183 in the thickness direction of the cover shell 20 to limit the battery 183. In at least one embodiment, there are two first connecting arms 41. One end of each first connecting arm 41 is fixed to the first shell 21 through screws. Another end of the first connecting arm 41 is connected to the support portion 42. The support portion 42 is flat plate. The support portion 42 is perpendicular to the first connecting arm 41. The support portion 42 is used to support the battery 183. Since the first connecting arm 41 is perpendicular to the support portion 42, the first connecting arm 41 can be resisted against the battery 183 and limit the position of the battery 183. In at least one embodiment, there are two second connecting arms 31, which are connected to both ends of the curved blocking plate 32. The second shell 22 is connected to the curved blocking plate 32 through the two second connecting arms 31. The second connecting arm 31 extends a certain distance towards the thickness direction of the cover shell 20 in order to place the battery 183. Due to the large size of the battery 183, the space for receiving the battery 183 can be increased by extending the second connecting arm 31. The curved blocking plate 32 is a quarter of arc. In the thickness direction of the cover shell 20, the curved blocking plate 32 is blocked at the front side of the battery 183, and the first connecting arm 41 is blocked at the rear side of the battery 183. The battery 183 is further supported by the support portion 42. Therefore, the first connecting arm 41, the support portion 42, and the curved blocking plate 32 cooperatively limit the position of the battery 183. The structure is simple, and the disassembly process is convenient.

Referring to FIG. 20, in at least at least one embodiment, the battery installation shell 30 further includes side blocking plates 33. The side blocking plates 33 are connected to edges of the curved blocking plate 32 in the length direction of the cover shell 20. The side blocking plates 33 can also limit the position of the battery 183. The number of side blocking plates 33 is two, and the side blocking plates 33 are located at the two edges of the curved blocking plate 32. The two side blocking plates 33 are resisted against to the ends of the battery 183, thereby limiting the position of the battery 183 and preventing the battery 183 from separating from the battery installation shell 30.

Referring to FIGS. 21 and 22, in at least one embodiment, the housing 50 includes an inner housing 51 and an outer housing 52. The inner housing 51 and the outer housing 52 connect to each other to receive the cover shell 20 in the housing 50. Each of the inner housing 51 and the outer housing 52 is fixed to the battery fixing base 40. The housing 50 is a surface housing of the entire massager. The cover shell 20 is a shell for receiving the drive mechanism 10, and the cover shell 20 is received in the housing 50. The inner housing 51 is a housing for fitting the neck, and the outer housing 52 is a housing far away from the neck. The housing 50 is formed by connecting the inner housing 51 and the outer housing 52 together. There is a cavity inside the housing 50, and the cover shell 20 is received in the cavity. The shape of the entire housing 50 matches the shape of the cover shell 20, which minimizes the size of the housing 50. At the same time, each of the inner housing 51 and the outer housing 52 is fixed to the battery fixing base 40. For example, the inner housing 51 is connected to the battery fixing base 40 through a buckle, and the outer housing 52 is fixed to the battery fixing base 40 through a screw. Other fixing manners may also be used, which are not limited in the present application. Since the outer housing 52 and the inner housing 51 are connected together and further fixed to the battery fixing base 40, the installation of the housing 50 is more secure, and the connection between the housing 50 and the cover shell 20 is tight, resulting in high reliability.

Referring to FIG. 22, in at least one embodiment, the inner housing 51 further forms an avoidance area 511 in the width direction of the cover shell 20. When the inner housing 51 is fixed to the battery fixing base 40, the support portion 42 is filled in the avoidance area 511. Since the battery installation shell 30 and battery fixing base 40 are located outside the receiving space and in the width direction of the cover shell 20, when the outer housing 52 and the inner housing 51 are connected together to completely cover both the battery installation shell 30 and battery fixing base 40 inside, it will result in a wider width and larger size of the entire housing 50. In the embodiment, the avoidance area 511 is arranged on the inner housing 51, which can match the support portion 42 of the battery fixing base 40 in shape. When the inner housing 51 is connected to the outer housing 52, the support portion 42 is exactly located in and filled in the avoidance area 511. Thus, the width of the inner housing 51 is reduced, and the inner housing 51 does not need to completely cover the battery fixing base 40. An exposed area (i.e., the avoidance area 511) can be set, and the support portion 42 of the battery fixing base 40 serves as a portion of the inner housing 51, which reduces the width of the inner housing 51.

In addition, the support portion 42 defines a screw opening on its front side in the thickness direction of the cover shell 20. A buckle is provided on the rear side of the support portion 42 in the thickness direction of the cover shell 20. When the outer housing 52 is connected to the inner housing 51, the support portion 42 is located in the avoidance area 511 of the inner housing 51. The inner housing 51 is fixed to the battery fixing base 40 through the engagement between the screw and the screw opening. The outer housing 52 is fixed with the battery fixing base 40 through the engagement between the buckle and a slot, thereby completing the assembly of the housing 50.

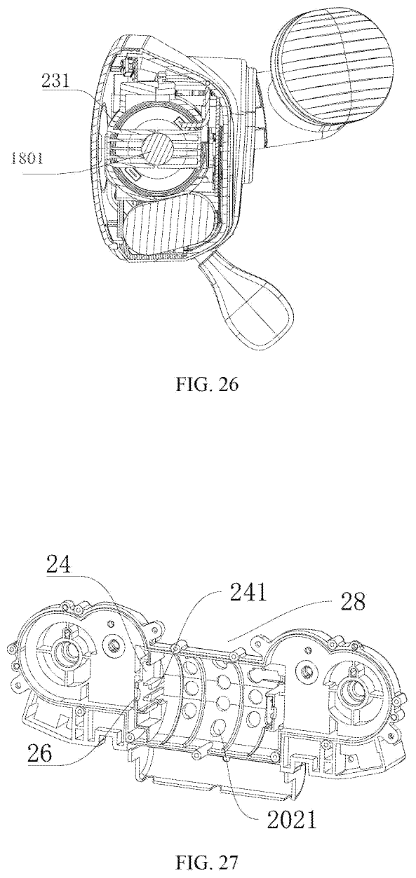

Referring to FIGS. 23-26, in at least one embodiment, two end surfaces of the motor 180 include protrusions 1801. At least one of the first shell 21 and the second shell 22 further includes a first wall 23 for separating and isolating the second receiving chamber 202 from the first receiving chamber 201. A number of second reinforcing ribs 231 are formed on the first wall 23, and each of the second reinforcing ribs 231 extends in the thickness direction of the cover shell 20. Ends of the second reinforcing ribs 231 are resisted against the periphery of one protrusion 1801 to support the protrusion 1801. The entire cover shell 20 may vibrate caused by the motor 180 during operation, especially, the output shafts located on both sides of the motor 180 may have the highest vibration intensity. In order to reduce the vibration caused by the motor 180, the second reinforcing ribs 231 are set in the embodiment to reduce the vibration of the motor 180. In at least one embodiment, the first receiving chamber 201 is separated from the second receiving chamber 202 by the first wall 23 on the first shell 21, and the second reinforcing ribs 231 are arranged on the first wall 23. The motor 180 is located in the second receiving chamber 202. The output shaft of the motor 180 passes through the first wall 23 and further connects to the gear group located in the first receiving chamber 201. The protrusions 1801 formed on the end surfaces of the motor 180 may be short cylinders. The second reinforcing ribs 231 have different lengths, and a line connecting the ends of the second reinforcing ribs 231 is substantially semi-circular. The ends of the second reinforcing ribs 231 are connected to the periphery of the protrusion 1801 and match the shape of the protrusion 1801. Therefore, the second reinforcing ribs 231 can support the protruding portion 112 of the motor 180, so that the protruding portion 112 of the motor 180 can be supported during operation, thereby reducing the vibration of the motor 180. In other embodiments, the second shell 22 may also have a structure similar to that of the second reinforcing ribs 231 of the first shell 21. The protrusions 1801 of the motor 180 are supported and limited by the second reinforcing ribs 231 on the first shell 21 and the second reinforcing ribs 231 on the second shell 22, thereby reducing the vibration.

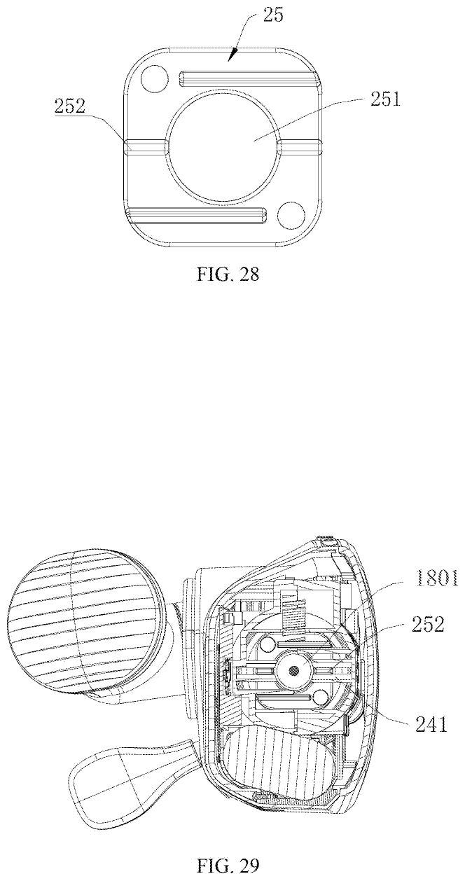

Referring to FIGS. 27 to 29, in at least one embodiment, the massager further includes a fixing plate 25. The fixing plate 25 defines a first through hole 251. At least one of the first shell 21 and the second shell 22 further includes a second wall 24 for separating and isolating the second receiving chamber 202 from the third receiving chamber 203. The fixing plate 25 is sleeved on one protrusion 1801 through the first through hole 251, and is installed on the second wall 24. The fixing plate 25 in the embodiment can further reduce the vibration caused by the motor 180 during operation. In at least one embodiment, the second receiving chamber 202 and the third receiving chamber 203 are separated from each other by the second wall 24 of the first shell 21. The fixing plate 25 is installed on the second wall 24. The first through hole 251 is defined in the fixing plate 25, and the protrusion 1801 on one end surface of the motor 180 passes through the first through hole 251 of the fixing plate 25. Thus, the protrusion 1801 of the motor 180 is supported by the fixing plate 25, thereby reducing the vibration caused by the motor 180.

A guide slot 241 is formed in the second wall 24 and extends in the thickness direction of the cover shell 20. A first through hole 251 is formed in the fixing plate 25. The guide strip 252 is inserted into the guide slot 241 to assemble the fixing plate 25 to the first shell 21. In at least at least one embodiment, the fixing plate 25 is substantially rectangular. The first through hole 251 is circular that matches the shape of the protrusion 1801. The guide strip 252 protrudes from the fixing plate 25 and extends along a straight line. The guide slot 241 that matches the guide strip 252 is formed on the second wall 24. When the fixing plate 25 needs to be assembled to the first shell 21, it only needs to insert the guide strip 252 into the guide slot 241. Thus, the assembly process is simple and convenient. Moreover, since the guide strip 252 is located in the guide slot 241, the guide slot 241 can also limit the position of the guide strip 252, which can prevent the fixing plate 25 from shaking and further improve the resistance to vibration. In other embodiments, the second shell 22 also forms a structure with the same guide slot 241 as the first shell 21, and the guide strip 252 is located in the guide slot 241 of the two shells to improve seismic resistance. Moreover, an installing hole is formed in the end surface of the motor 180. The fixing plate 25 is fixed to the installing hole by screws. The motor 180 and the fixing plate 25 are assembled together, so that the vibration of motor 180 can be transmitted the to the fixing plate 25. The fixing plate 25 is limited by the guide slot 241, thereby counteracting the vibration of the motor 180 and achieving the resistance to vibration.

Referring to FIGS. 25 and 27, in addition, a second through hole 26 is further defined in each of the first wall 23 and the second wall 24 for the corresponding output shaft of the motor 180 to pass through. In at least one embodiment, one first wall 23 of the first shell 21 defines a first notch, and one first wall 23 of the second shell 22 defines a second notch. The first and the second notches cooperatively form one second through hole 26. Similarly, another first wall 23 of the second shell 22 defines a third notch, and another second wall 24 of the second shell 22 defines a fourth notch. The third and the fourth notches cooperatively form another second through hole 26.

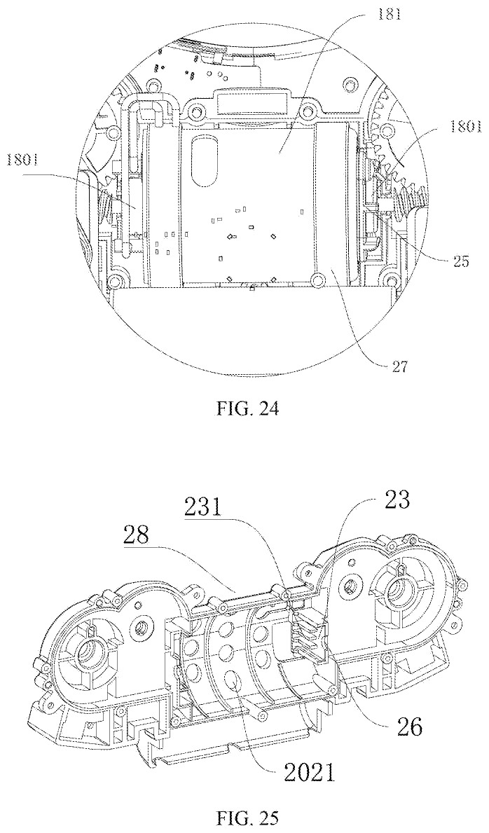

Referring to FIG. 24, furthermore, the massager further includes a vibration absorbing washer 27. The vibration absorbing washer 27 is sleeved on the motor 180. The vibration absorbing washer 27 sleeved on the motor 180 can further reduce the vibration of the motor 180. The vibration absorbing washer 27 may be a rubber ring, which reduces the vibration transmitted from the motor 180 to the cover shell 20.

Referring to FIGS. 25 and 27, in at least one embodiment, in the width direction of the cover shell 20, the width of the second receiving chamber 202 is smaller than each of the width of the first receiving chamber 201 and the width of the third storage chamber 203, so that an avoidance position 28 is formed in one side of the cover shell 20 opposite to the battery installation shell 30. When the massager is worn on the neck, the neck is located in the width direction of the cover shell 20. Therefore, in order to reserve space for the neck to adapt to the shape of the neck, the second receiving chamber 202 is set to be narrower relative to each of the first receiving chamber 201 and the third receiving chamber 203 in at least one embodiment. That is, the middle of the cover shell 20 is narrower, and both sides of the cover shell 20 are wider, thereby forming the avoidance position 28. The battery installation shell 30 is located on the lower side of the cover shell 20, and the avoidance position 28 is located on the upper side of the of the cover shell 20 and corresponds to the position of the neck. Therefore, when worn on the neck, the neck can be received in the avoidance position 28, making the entire neck massager to fit the neck better and improving the massage effect. Accordingly, the housing 50 covering the outer side of the cover shell 20 can be designed to have a curved surface with a certain degree of curvature. The curved surface corresponds to the position of the avoidance position 28 and can fit the neck better.

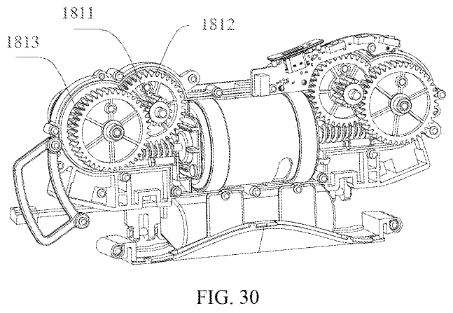

Referring to FIG. 30, in an embodiment, each of the first transmission component 181 and the second transmission component 182 include a first gear 1811, a second gear 1812, and a third gear 1813. The first gear 1811 and the second gear 1812 rotate coaxially, and are driven by the driving component 18. A diameter of the first gear 1811 is smaller than a diameter of the second gear 1812. The third gear 1813 at least partially overlaps with the second gear 1812 in the thickness direction of the cover shell 20. The third gear 1813 is engaged with the first gear 1811. The third gear 1813 is connected to the first massage head 200. In at least one embodiment, each of the first shell 21 and the second shell 22 is defined with a shaft hole. The transmission shaft 11 is rotatably arranged in the shaft hole. The first gear 1811 and the second gear 1812 are both connected to and driven by the transmission shaft 11. Since the diameter of the first gear 1811 is smaller than the diameter of the second gear 1812, the first gear 1811 is a small gear and the second gear 1812 is a large gear. Since the third gear 1813 is engaged with the first gear 1811, the third gear 1813 is engaged with the small gear. The third gear 1813 and the second gear 1812 are respectively connected to the two left massage heads or to the two right massage heads. Since the third gear 1813 is engaged with the small gear (i.e., the first gear 1811), the third gear 1813 is arranged side by side with the small gear (i.e., the first gear 1811). A portion of the third gear 1813 overlaps with the second gear 1812 in the thickness direction of the cover shell 20. The third gear 1813 and second gear 1812 are located at different layers. Therefore, in the length direction of the cover shell 20, the space occupied by the third gear 1813 and the second gear 1812 is reduced. The length of the cover shell 20 is reduced, which further reduces the size of the massager.

Referring to FIGS. 25 and 27, in at least one embodiment, the second receiving chamber 202 further defines a number of heat dissipation holes 2021. The heat dissipation holes 2021 may be circular. The heat dissipation holes 2021 can dissipate the heat from the motor 180 received on the second receiving chamber 202, which improve heat dissipation efficiency.

With the above configuration, the first shell 21 and the second shell 22 cooperatively define three receiving chambers. The motor 180 is received in the middle receiving chamber in the length direction. The first and the second transmission components 12 and 13 are respectively installed on the two receiving chambers on both sides. The battery fixing base 40 is located in the width direction and next to the receiving chamber of the motor 180. When the massager is worn on the neck, the receiving chamber of the motor 180 is located in the middle of the neck, the receiving chambers of the first and the second transmission components 12 and 13 are located on both sides of the neck, and the battery 183 is located on the lower side of the motor 180. Thus, the structure of whole massager is reasonable and compact, and can fit the neck of the human body better. The massager is also small in size and light in weight, so the user may not sense heavy when wearing the massager on the neck, thereby improving the user experience.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

What is claimed is:

1. A massager for shoulders and neck, comprising:
a wearing body configured to be worn on the neck; and
a second massage head;
wherein the wearing body comprises a cover shell and a driving mechanism installed on the cover shell, the driving mechanism comprises a transmission shaft rotatably installed on the cover shell, a second connecting piece eccentrically and rotatably connected to the transmission shaft, a movable component movably connected to the cover shell, and a swing component pivotally connected to the cover shell;
wherein the movable component is located on a side of the transmission shaft, the second massage head is connected to the swing component, the second connecting piece is pivotally connected to the movable component, the movable component is rotatably and slidably connected to the swing component, the transmission shaft is configured to drive the swing component and the second massage head to swing through the second connecting piece and the movable component when the transmission shaft rotates, thereby forming massage actions on the shoulders.

2. The massager according to claim 1, wherein the driving mechanism further comprises an eccentric transmission component installed on the transmission shaft, the eccentric transmission component comprises an eccentric transmission portion, the transmission shaft is located at an eccentric position of the eccentric transmission portion, the second connecting piece is rotatably sleeved on the eccentric transmission portion, thereby enabling the second connecting piece to be eccentrically and rotatably connected to the transmission shaft.

3. The massager according to claim 1, wherein one of the swing component and the movable component defines a sliding groove being strip-shaped, and the other one of the swing component and the movable component comprises a sliding rod, the sliding rod is rotatably and slidably connected to the sliding groove, thereby enabling the movable component to be rotatably and slidably connected to the swing component.

4. The massager according to claim 3, wherein the cover shell defines a guide groove extending in a width direction of the cover shell, the movable component is slidably connected to the guide groove, and the second connecting piece is configured to drive the movable component to slide back and forth in the guide groove.

5. The massager according to claim 4, wherein an end of the movable component comprises two connecting ears, the movable component comprises the sliding rod, the swing component defines the sliding groove, the sliding rod passes through the sliding groove and is fixed to the two connecting ears; the sliding rod is configured to drive the swing component to rotate when the sliding groove slides, thereby enabling the swing component to swing in the width direction of the cover shell.

6. The massager according to claim 3, wherein the swing component comprises a first arm segment, a second arm segment, and a third arm segment, one end of the first arm segment is pivotally connected to one side of the cover shell away from the second massage head, one end of the second arm segment is connected to another end of the first arm segment, the second arm segment bypasses a surface of the cover shell and extends in a thickness direction of the cover shell, another end of the second arm segment is connected to one end of the third arm segment, another end of the third arm segment is connected to the second massage head, and the sliding groove is defined in the third arm segment.

7. The massager according to claim 6, wherein the side of the cover shell away from the second massage head comprises a first limit arm and a second limit arm, each of the first and the second limit arms is formed in the width direction of the cover shell and extends in the thickness direction of the cover shell, the first and the second limit arms cooperatively define a swinging space, the first arm segment extends into the swinging space defined by the first limit arm and the second limit arm, and one end of the first arm segment is pivotally connected between the first limit arm and the second limit arm.

8. The massager according to claim 6, wherein the cover shell further defines a notch in the thickness direction of the cover shell, the notch is configured to receive the second arm segment; and/or
the sliding rod is configured to move in the sliding groove between a first position and a second position, wherein when the sliding rod is in the first position, the sliding rod is near the second massage head, when the sliding rod is in the second position, the sliding rod is away from the second massage head, the third arm segment is configured to swing away from the cover shell in the width direction of the cover shell when the sliding rod slides to the first position, and the third arm segment is configured to swing toward the cover shell in the width direction of the cover shell when the sliding rod slides to the second position.

9. The massager according to claim 2, wherein the eccentric transmission component defines a shaft installing hole located at the eccentric position of the eccentric transmission portion, the transmission shaft is installed in the shaft installing hole;
the eccentric transmission component further comprises a swing driving surface, inclined with an axis of the shaft installing hole, and a rotation driving portion protruding from the swing driving surface.

10. The massager according to claim 9, wherein the eccentric transmission component further comprises a swinging rotating surface opposite to the swing driving surface, and the eccentric transmission portion protrudes from the swinging rotating surface;
wherein a maximum distance and a minimum distance exist between the swing driving surface and the swinging rotating surface in an extension direction of the axis of the shaft installing hole, a distance between the swing driving surface and the swinging rotating surface gradually increases from the minimum distance to the maximum distance, thereby enabling the swing driving surface to be inclined with the axis of the shaft installing hole.

11. The massager according to claim 9, wherein the driving mechanism further comprises a driving component and a first connecting piece, the driving component is configured to drive the transmission shaft to rotate;
the massager further comprises a first massage head, the first massager head is connected to the first connecting piece, the second massage head is connected to the second connecting piece;
wherein the first connecting piece is rotatably connected to the rotation driving portion, and is resisted against the swing driving surface, thereby enabling the swing driving surface to drive the first connecting piece to swing when the transmission shaft drives the eccentric transmission component to rotate;
the second connecting piece is rotatably sleeved on the eccentric transmission portion, thereby enabling the eccentric transmission portion to drive the second connecting piece to swing eccentrically when the transmission shaft drives the eccentric transmission component to rotate.

12. The massager according to claim 11, wherein the eccentric transmission component further comprises a fixing cover and an outer flange gasket, the fixing cover is fixed to an end surface of the rotation driving portion away from the swing driving surface, an edge of the fixing cover protrudes from an outer periphery of the rotation driving portion;
the first connecting piece is barrel-shaped, the first connecting piece is rotatably sleeved on the rotation driving portion, and is resisted against the swing driving surface, the first connecting piece comprises an inner flange, the outer flange gasket is sleeved on the rotation driving portion, and is located between the inner flange and the edge of the fixing cover.

13. The massager according to claim 1, wherein the driving mechanism further comprising a first transmission component, a second transmission component, and a battery, each of the first transmission component and the second transmission component is connected to the driving component, the battery is configured to supply electric power to the driving component;
the massager further comprises a cover shell configured to receive the driving mechanism, the cover shell comprises a first shell and a second shell, the first shell and the second shell connected to each other to define a receiving space, the receiving space defines a first receiving chamber, a second receiving chamber, and a third receiving chamber in a length direction of the cover shell, the first receiving chamber and the third receiving chamber are located on two respective sides of the second receiving chamber;
the massager further comprises a battery installation shell connected to at least one of the first shell and the second shell, the battery installation shell is located in a width direction of the cover shell and adjacent to the second receiving chamber;
wherein the first transmission component is received in the first receiving chamber, the driving component is received in the second receiving chamber, the second transmission component is received in the third cover shell, and the battery is received in the battery installation shell.

14. The massager according to claim 13, wherein the massager further comprises a battery fixing base detachably connected to the first shell, the battery fixing base is located in the width direction of the cover shell and adjacent to the second receiving chamber, the battery fixing base and the battery installation shell cooperatively receive the battery.

15. The massager according to claim 14, wherein the battery fixing base comprises a first connecting arm and a support portion, one end of the first connecting arm is connected to the support portion, and another end of the first connecting arm is connected to the first shell;
the battery installation shell comprises a second connecting arm and a curved blocking plate, one end of the second connecting arm is connected to the second shell, another end of the second connecting arm is connected to the curved blocking plate, and the second connecting arm extends in a thickness direction of the cover shell;
the battery is disposed on the support portion, and the first connecting arm and the curved blocking plate are respectively located on two respective sides of the battery in the thickness direction of the cover shell to limit a position of the battery.

16. The massager according to claim 15, wherein the wearing body further comprises a housing, the housing comprises an inner housing and an outer housing, the inner housing and the outer housing are connected to each other and cooperatively receive the cover shell, the inner housing and the outer housing are both fixed to the battery fixing base; wherein the inner housing further comprises an avoidance area in the width direction of the housing, and the support portion is configured to be filled in the avoidance area when the inner shell is fixed to the battery fixing base.

17. The massager according to claim 13, wherein the driving component comprises a motor, two end surfaces of the motor comprises protrusions, at least one of the first shell and the second shell comprises a first wall configured to separate the second receiving chamber from the first receiving chamber, a plurality of second reinforcing ribs is formed on the first wall and extends along the thickness direction of the cover shell, and ends of the plurality of second reinforcing ribs are connected to and support a periphery of one of the protrusions.

18. The massager according to claim 17, further comprising a fixing plate, wherein the fixing plate defines a first through hole; at least one of the first shell and the second shell further comprises a second wall for separating the second receiving chamber from the third receiving chamber; the fixing plate is sleeved on the one of the protrusions through the first through hole, and is installed on the second wall.

19. The massager according to claim 18, wherein a guide slot is formed in the second wall and extends in the thickness direction of the cover shell, a guide strip is formed on the fixing plate, and the guide strip is configured to be inserted into the guide slot to connect the fixing plate to the first shell.

20. The massage according to claim 13, wherein each of the first transmission component and the second transmission component comprises a first gear, a second gear, and a third gear, the first gear and the second gear rotate coaxially, the first gear and the second gear are configured to be driven by the driving component; a diameter of the first gear is smaller than a diameter of the second gear, the third gear at least partially overlaps with the second gear in the thickness direction of the cover shell, and the third gear is engaged with the first gear and connected to a first massage head.
